(19) United States
(12) Patent Application Publication
(10) Pub. No.: US 2007/0251400 A1
(43) Pub. Date: Nov. 1, 2007

(54) Platen Press

(76) Inventors: Arthur J. Glass, Newbury, OH (US); Bryon J. Sanford, Mentor, OH (US)

Correspondence Address: John R. Hlavka;Watts Hoffmann Co., P.O. Box 99839, Cleveland, OH, 44199-0839, US

(21) Appl. No.: 10/574,460

(22) PCT Filed: Oct. 8, 2004
(86) PCT No.: PCT/US04/33445

§ 371 Date: Feb. 28, 2007

Related U.S. Application Data
(60) Provisional application No. 60/509,964, filed on Oct. 9, 2003.

(51) Int. Cl. B30B 1/34

(52) U.S. Cl. 100/269.01

(57) ABSTRACT

A platen press and method for operating a platen press that includes a fixed upper bolster (10) and a lower movable bolster (12) between which is positioned a plurality of platens (14). Fluid operated jack cylinders (17) are used to move the movable bolster to a closed position whereas separate main or clamping cylinders (16) apply a clamping force to the platens when the press is closed. A first source of pressurized fluid (104, 104′) supplies pressurized fluid at first pressure to the jack cylinders during a press closing step. A second source of pressurized fluid (134) at a second pressure, lower than the first pressure prefills (via prefill valves (146)) the main cylinders during the closing step. When the press is closed, the communication of the second source of pressurized fluid to the main cylinders is terminated and the first source of pressurized fluid is communicated to the main cylinders in order to generate the clamping force. The first source of pressurized fluid is a high pressure low volume source such a positive displacement pumps (104, 104′) used in connection with an accumulator (172). The second pressurized source is a high volume, low pressure source such as a centrifugal pumps (134), an accumulator (200) fed by a fluid pump (204) or a flow intensifier operated by fluid pump.

### TECHNICAL FIELD

The present invention relates generally to platen presses and, in particular to a method and apparatus for increasing the operating speed of platen presses of the type that utilizes jack cylinders to close the press.

### BACKGROUND ART

Presses having multiple moving platens are commonly used to process sheet material, such as rubber and wood products. In the type of press to which this invention pertains, the platens are clamped between a fixed upper bolster and a movable lower bolster (termed an “up-stroking” press). Jack cylinders are used to raise the lower bolster during the press closing cycle. Main cylinders, which are substantially larger than the jack cylinders, are pressurized, after the press is closed, and exert a significant upward force on the movable bolster in order to create a clamping force on the platens.

In this type of press, the actuating rods of the main cylinders are attached to the movable bolster so as the jack cylinders raise the bolster during the closing cycle, the main cylinder rods are also raised. In prior art presses of this type, the main cylinders are filled (often termed “prefilled”) with oil as the press closes, from a tank or reservoir connected to the main cylinders. In these prior art presses, the tank is located above the main cylinders and gravity is utilized to urge the fluid into the main cylinders. In these prior art presses, the rate of flow of this gravity fed fluid is determined by the height of the tank and the size of the piping feeding the cylinders. It has been found that the closing speed of the press is at least somewhat dependent on the rate at which the fluid can flow from the tank into the main cylinders.

### DISCLOSURE OF INVENTION

The present invention provides a new and improved platen press and method for operating a platen press. According to the invention, the platen press includes a fixed bolster and a movable bolster between which is positioned at least one platen. At least one fluid pressure operated jack cylinder is operative to move the movable bolster to a closed position. At least one main, pressurizing or clamping cylinder is used to apply clamping force to a platen clamped between the fixed and movable bolster.

In the illustrated embodiment, the platen press includes multiple moving platens and multiple main and jack cylinders. The platen press includes a first source of pressurized fluid which is communicated to the jack cylinders in order to move the movable bolster to its closed position. While the jack cylinders are closing the movable bolster, a second source of pressurized fluid is communicated to the main cylinders in order to prefill the cylinders prior to a platen clamping step. In the preferred and illustrated embodiment, the first source of pressurized fluid provides pressurized fluid at a relatively high pressure but low volume whereas the second source of pressurized fluid provides pressurized fluid at a lower pressure but a much higher volume. During a clamping step, i.e., when the platens are clamped between the fixed and movable bolster, the first source of pressurized fluid is communicated to the main cylinder in order to create the clamping force on the platens.

The press includes control valving for controlling the communication of the first and second sources of pressurized fluid with the jack and main cylinders. In the preferred and illustrated embodiment, solenoid operated control valves are used to control the communication of the pressurized fluid sources with the jack and main cylinders. Control valves are also used to control the discharge of fluid from these cylinders when the press is opened.

According to one embodiment, the first source of pressurized fluid comprises at least one but preferably multiple positive displacement pumps. In a more preferred embodiment, the first source also includes an accumulator that is charged by at least one of the positive displacement pumps during at least portions of a press operating cycle.

According to one embodiment, the second source of pressurized fluid comprises at least one but preferably multiple high volume centrifugal pumps. These pumps are capable of providing large amounts of fluid to fill the main cylinders during the press closing cycle, at a relatively low pressure.

According to another embodiment, the second source of pressurized fluid comprises an accumulator fed by a positive displacement pump. In the preferred operating method, the positive displacement pump operates relatively continuously thereby delivering fluid to the accumulator through much of the press operating cycle. During a press closing step, the accumulator is communicated with the main cylinder (via prefill valves). With this arrangement, large amounts of fluid can be delivered to the main cylinders during the press closing step.

According to another embodiment, a flow intensifier arrangement is used to pre-fill the main cylinders during the press closing step. In this embodiment, a positive displacement pump is used to drive at least one flow intensifier. The flow intensifier has an output connected to the main cylinders via a control valve. During the press closing step, the control valve allows fluid from the intensifier to flow into the main cylinder. The positive displacement pump forming part of the intensifier system effects the piston movement in the flow intensifier. During the press opening cycle, the fluid discharged by the main cylinder is simply returned to the flow intensifier rather than to a tank or reservoir as is the case with the other embodiments.

With the disclosed apparatus and method, cycle times for a platen press of the type to which this invention pertains, is decreased. By using separate sources of pressurized fluid, movement of the moving bolster by the jack cylinders can proceed at a higher rate since the main cylinders are being prefilled by a high volume, low pressure source rather than from a gravity fed reservoir.

Additional features of the invention will become apparent and a fuller understanding obtained by reading the following detailed description made in connection with the accompanying drawings.

### BRIEF DESCRIPTION OF DRAWINGS

FIG. 1 is a perspective view of a platen type press embodying the present invention;

FIG. 2 is a schematic representation of a fluid pressure operated control system for controlling main and jack cylinders forming part of the press shown in FIG. 1;

FIG. 2a is an enlargement of a portion of the schematic shown in FIG. 2 in order to more clearly illustrate the componentry;

FIG. 2b is another enlarged portion of the circuit shown in FIG. 2;

FIG. 2c is still another enlargement of a portion of the circuit shown in FIG. 2;

FIG. 3 is alternate embodiment of the circuit portion shown in FIG. 2a; and,

FIG. 4 is another embodiment of the circuit portion shown in FIG. 2a.

### BEST MODE FOR CARRYING OUT THE INVENTION

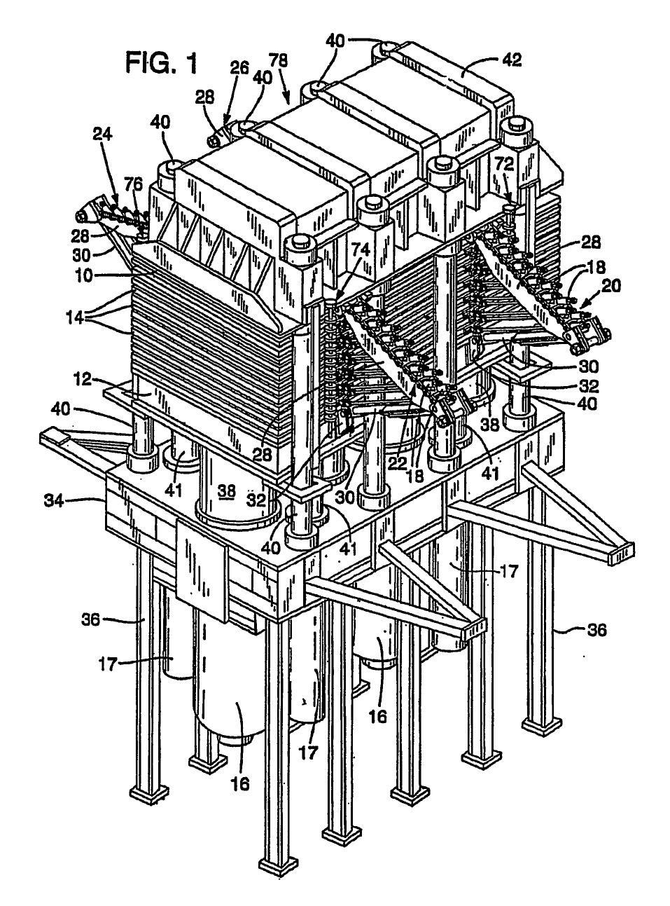

FIG. 1 illustrates the overall construction of a multiple platen press which includes a fixed upper bolster 10 and a movable lower bolster 12, between which are positioned a plurality of movable platens 14. The movable bolster 12 is moved upwardly by several main ram cylinders 16, and by a plurality of jack ram cylinders 17 which are positioned in a balanced and symmetrical manner. The construction of the main ram cylinders 16 and the jack ram cylinders 17 may be conventional. In general the jack cylinders 17 are used to close the press i.e. move the bolster 12 from a lowered position to an upper position where the platens are clamp together between the upper and lower bolsters 10, 12. The main cylinders 16 are then pressurized to apply an significant clamping force to the platens during a curing or vulcanizing step.

Each of the movable platens 14 is connected to a plurality of control cylinders 18 which are arranged in four groups of cylinders 20, 22, 24, 26, each group being mounted on a separate support assembly 28 which is pivotally connected at one end to the fled upper bolster 10. The other end of the support assembly 28 is pivotally connected to the upper end of a pivot arm 30 which is pivotally attached at its lower end to a bracket 32 fixed to the movable lower bolster 12. In operation, the movable platens 14 are clamped between the movable lower bolster 12 (which moves upwardly) and the fixed upper bolster 10. The lower bolster 12 is moved upwardly by the jack ram cylinders 17.

Each of the movable platens 14 is connected to four or more adjusting cylinders 18, each form a different one of the four or more groups of cylinders 20, 22, 24, 26 adjacent to the four corners of the platen. These four control cylinders maintain the platen level in a precisely adjusted spacing relative to its adjacent platen. The control system and hardware for achieving the control movement of the lower bolster 12 and platens 14 is considered conventional. A detailed description of the mechanism by which the movement in the platens is controlled can be found in U.S. Pat. No. 5,634,398, owned by the present assignee and hereby incorporated by reference.

As is also conventional, the press, including the main and jack ram cylinders 16 and 17, is mounted on a fixed frame 34 secured to a concrete pad by legs 36 in a conventional manner. Each of the main ram cylinders 16 includes a piston 38 which is secured to the bottom of the movable lower bolster 12 and is movable upwardly in a parallel relationship with a plurality of vertical guide rods or columns 40. In like manner, each of the jack ram cylinders 17 includes a piston 41 which is secured to the bottom of the movable lower bolster 12 and is operative to move the lower bolster upwardly during a press closing portion of a processing cycle. The upper bolster 10 is fixed to the frame by attachment to the top of the guide rods 40 and to a press cap 42 in a conventional manner.

As is conventional, material to be processed is loaded onto each of the platens 14. The jack ram cylinders, 17 are connected to a source of fluid pressure which causes associated pistons to extend, thus raising the lower bolster 12. Concurrent with raising of the lower bolster 12, the control cylinders 18 are also raised due to the interaction of the pivot arm, thus raising the common support assemblies 28 upwardly. This motion raises all of the control cylinders 18 and, thus, raises the movable platens 14. The movement of the platens 14 is coordinated with the movement in the lower bolster so that all platens move to abutting contact concurrently, rather than sequentially as would occur if only the lower bolster 12 was used to move the platens 14 into abutting contact with each other.

As is known, a platen press of the type illustrated in FIG. 1 is used to process, cure, or vulcanize sheet material. In general, material to be processed is laid on the upper surface of each platen 14. After the material is placed on the platens 14, the press is closed, as described above, clamping the platens 14 together in a tight confronting relationship. The cylinders 16, 17 apply a desired clamping pressure so that the material to be processed, located between the platens, is under constant pressure during the processing cycle.

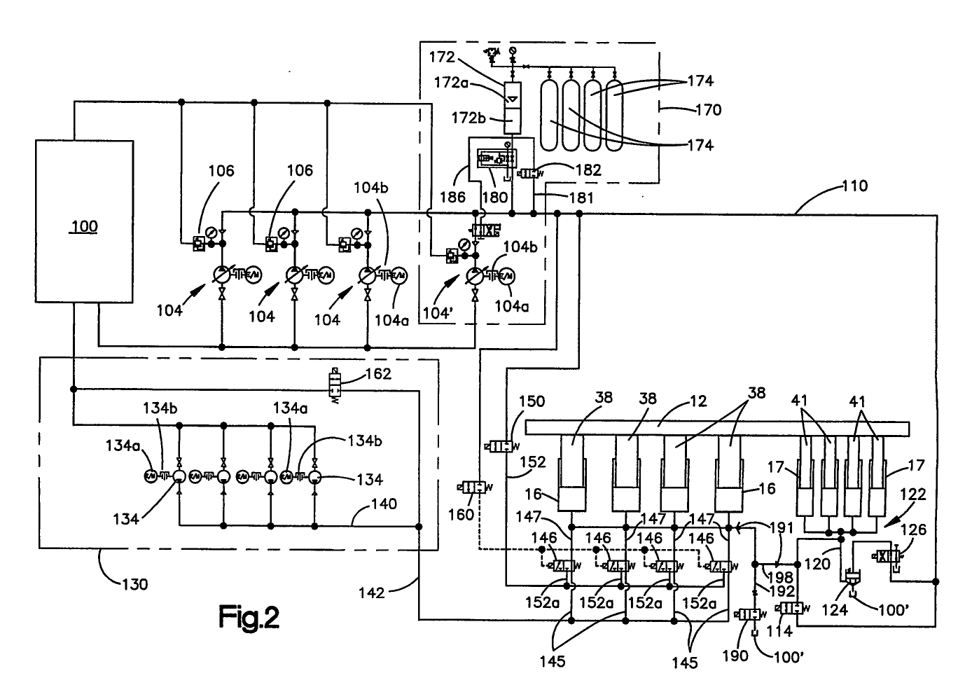

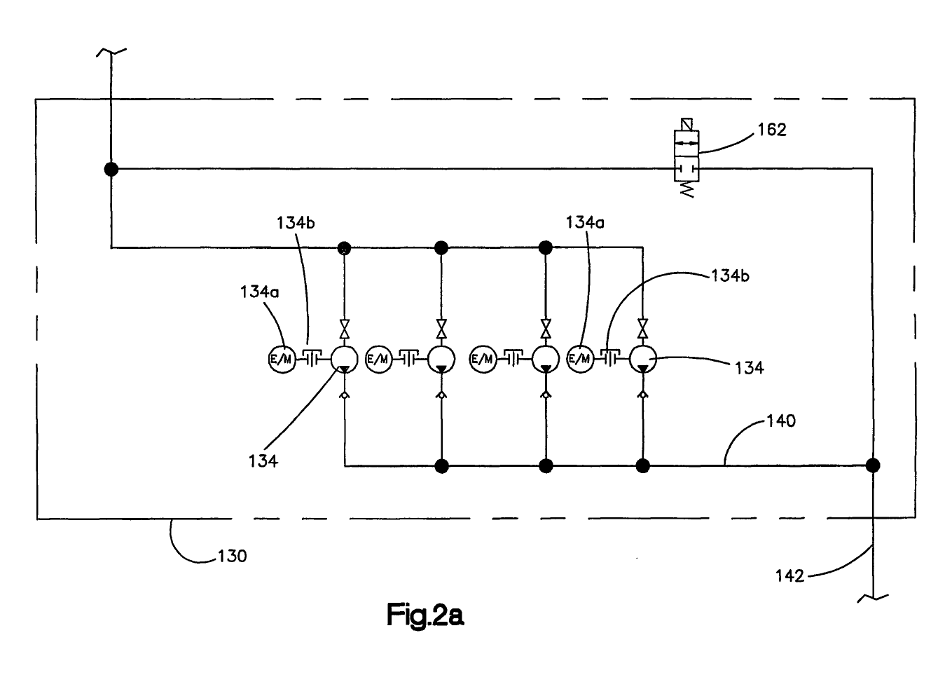

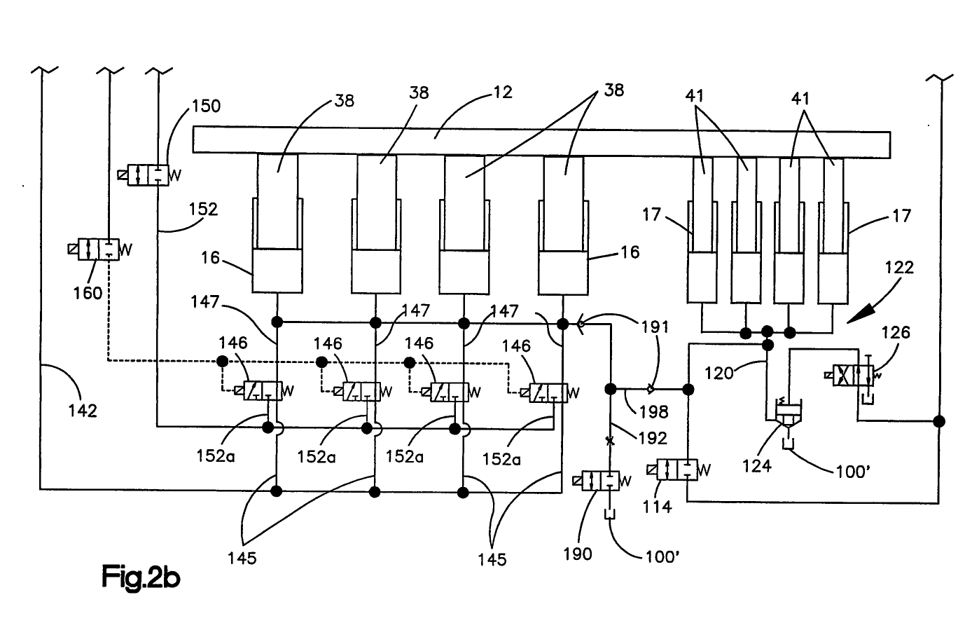

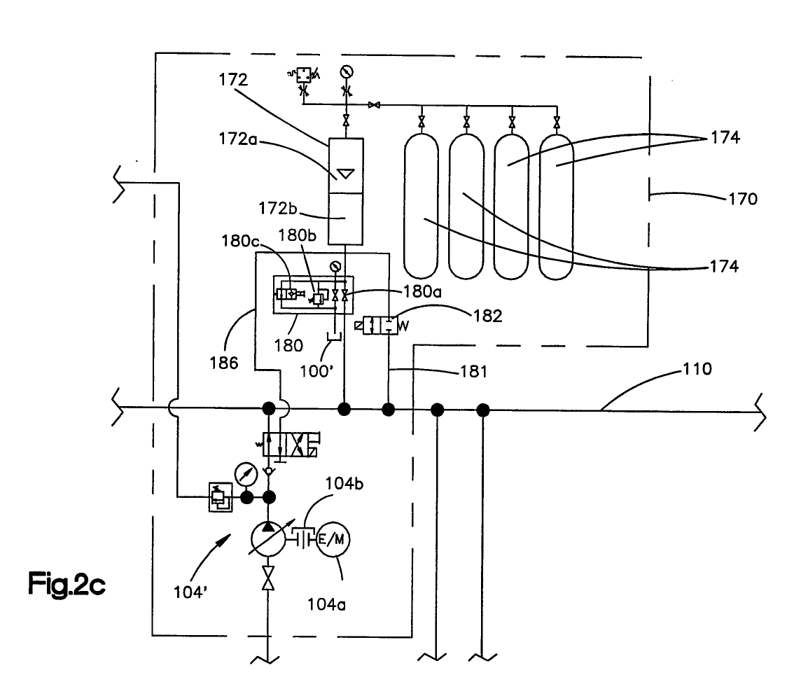

FIG. 2 schematically illustrates the fluid pressure system, i.e., hydraulic system that is used to operate the main cylinders 16 and the jack cylinders 17. As seen in both FIGS. 1 and 2, the jack cylinders 17 are substantially smaller than the main cylinders 16. As a consequence, the volume of fluid needed to extend the jack cylinders 17 is substantially smaller than the volume of fluid needed to extend the main cylinders 16. In the type of press illustrated in FIG. 1, the jack cylinders 17 are used to move the lower bolster 12 from its open position to its closed position and the main cylinders 16 are used to apply the necessary clamping force after the platen press is closed i.e., after the lower bolster 12 moves to its uppermost position.

The operating speed of the press shown in FIG. 1 is at least partially dependent upon the speed with which the jack cylinders can close the press, i.e., move the lower bolster 12 to its uppermost position, and the time it takes to fill and pressurize the main cylinders 16 to a pressure level that generates the required clamping force on the platens 14. As described above, the platens 14 are clamped between the fixed upper bolster 10 and the movable bolster 12.

In accordance with the invention, the disclosed hydraulic circuit substantially improves cycle time of the press by increasing the rate at which the jack cylinders raise the bolster and the rate at which the required fluid pressure level is developed in the main cylinders 16.

FIG. 2 illustrates one method and apparatus for improving the cycle time of the type of press illustrated in FIG. 1. The hydraulic system includes a tank 100, which acts as a reservoir for the hydraulic fluid. A source of high press fluid is provided by a plurality of positive displacement pumps 104, 104′ that are connected, generally in parallel. The pumps are capable of providing high-pressure fluid but at a relatively low volume. In the illustrated embodiment, each positive displacement pump 104 is driven by an electric motor 104a by means of a conventional coupling 104b. The output of each positive displacement pump is connected to an associated conventional pressure relief valve 106, which is operative to maintain a maximum pressure at the pump output. When a predetermined pressure is exceeded, the pressure relief valve 106 opens to dump fluid to the tank 100. As illustrated, the output of the positive displacement pumps 104 are connected directly to a high pressure supply conduit 110. The right most positive displacement pump 104′ is connected to the high pressure supply conduit 110 through a two-position electrically operated (i.e. solenoid operated) control valve 112. In the position of the control valve 112 shown in FIG. 2, the output of the right most positive displacement pump 104′ is directly connected to the supply conduit 110.

Referring also to FIG. 2b, an electrically operated two position control valve 114 controls the communication of the supply conduit 110 with the jack cylinders 17. In FIG. 2, the control valve is shown in the position where communication of the supply conduit 110 with the jack cylinders 117 is blocked. When the jack cylinders 17 are to be extended in order to raise the movable bolster 12, the control valve 114 is shifted towards the right (as viewed in FIG. 2) and in this position, the high-pressure supply conduit 110 is communicated to a cylinder feed conduit 120. The feed conduit 120 is connected to the jack cylinders via branch conduits indicated generally by the reference character 122. The feed conduit 120 is also connected to what is termed a DIN cartridge valve 124 which controls the communication of the feed conduit 120 with the tank 100. The communication of the DIN cartridge valve 124 with the tank 100 is illustrated schematically by the symbol that is marked as 100′. Those skilled in the art will recognize that the tank 100′ indicate that the DIN cartridge valve 124 communicates with the tank 100. The state of the DIN cartridge valve 124, i.e., whether it communicates the jack cylinder feed conduit 120 with the tank 100 is determined by an electrically controlled two-position valve 126. When the valve 126 is in the position shown in FIG. 2, it communicates high pressure fluid in the supply conduit 110 to the DIN control valve 124 and closes the valve 124 to thereby inhibit communication between the feed conduit 120 and the tank 100. When extension of the jack cylinders 17 is desired, the control valve 126 is placed in the position shown in FIG. 2 and the high-pressure control valve 114 is shifted to the right (as viewed in FIG. 2). When the valves 114, 126 are in this state, high pressure fluid in the supply conduit 110 is delivered to the jack cylinders 17 thus causing extension of the piston rods 41 (shown best in FIG. 1) thereby raising the movable bolster 12, thus effecting closure of the press.

As the jack cylinders 17 are being extended by virtue of the communication of fluid pressure from the supply conduit 110 to the cylinders 17, the main cylinders 16 are filled with fluid in preparation for the clamping or pressing portion of the cycle that occurs once the press is fully closed. In accordance with the invention, the main cylinder 16 are filled with fluid during the press closing step of the process cycle, by a low pressure, high flow delivery system indicated generally by the reference character 130. In the embodiment illustrated in FIG. 2, the low pressure, high flow delivery system includes a plurality of centrifugal pumps 134 that are all connected in parallel and which are operative to deliver relatively low pressure fluid from the tank 100 to the main cylinders 16. In the illustrated embodiment and referring also to FIG. 2a, four (4) centrifugal pumps 134 are utilized, each pump 134 being driven by an associated electric motor 134a through a conventional coupling 134b. It should be understood, that the number of centrifugal pumps utilized can vary depending on application. The output of the centrifugal pumps 134 are connected to a common supply conduit 140 which in turn is connected to a low pressure supply/return conduit or header 142. The supply/return conduit 142 feeds branch supply/return conduits 145 which are connected, via associated prefill valves 146 to associated main cylinders 16.

Each prefill valve 146 is a pilot pressure operated, two position, three way plunger-style control valve. In the absence of pilot pressure (its de-energized state), the control valve 146 is biased toward the left to the position shown in FIG. 2. In this position, the control valve 146 allows fluid flow from the associated branch supply/return conduit 145 to an associated cylinder conduit 147 that is connected to an associated main cylinder 16.

During the press-closing portion of the cycle, the hydraulic system operates as follows. As indicated above, the positive displacement high-pressure pumps operate continuously. To close the press, the control valve 114 is shifted to the right thus communicating high-pressure fluid to the jack cylinders 17. During this portion of the process cycle, the DIN cartridge valve 124 is maintained in its closed position by the control valve 126, which is shifted to the right in order to apply high pressure fluid to the DIN control valve 124 in order to maintain its closure. Prior to the pressurization of the jack cylinders 17, the centrifugal pumps 134 are energized to deliver low pressure fluid from the tank 100 to the main cylinders 16 via the de-energized prefill control valves 146. The centrifugal pumps 134 are capable of delivering a large volume of fluid to the main cylinders 16 so that they are kept filled as the jack cylinders 17 raise the lower bolster 12, which in turn raises the main cylinder rods 38 (shown best in FIG. 1) which are also attached to the lower bolster 12. In the illustrated embodiment, the pressurized fluid delivered to the main cylinders 16 during the press closing step is normally less than 50 psi and as a consequence, the main cylinders 16 themselves do not exert any significant raising force on the movable bolster 12 during the press closing step of the processing cycle.

When the press is fully closed, i.e., the lower bolster 12 reaches its upper position at which it begins exerting a clamping force on the platens 14 located between the fixed bolster 10 and movable bolster 12 (see FIG. 1), high pressure fluid is then communicated to the main cylinders 16 in order to generate the required clamping force between the fixed bolster 10 and the lower movable bolster 12. This is achieved by energizing a solenoid operated control valve 160 to shift it to the right. Shifting control valve 160 causes a pilot pressure to be applied to the prefill valves 146 causing them to move to the right (as viewed in FIG. 2). In this position of the prefill valves 146, the header 142 is isolated from the main cylinder conduits 147. Concurrently with the energization of the control valve 160, high pressure control valve 150 is energized in order to shift it to the right (as viewed in FIG. 2). The shifting of the control valve 150 causes high-pressure fluid to be communicated from the high pressure supply conduit 110 to a high pressure supply conduit 152 which is connected to each prefill valve 146 by a branch conduit 152a. As seen in FIG. 2, each branch conduit 152a is connected to an associated main cylinder feed conduit 147 via an associated prefill valve 146 when the prefill valved is energized by the pilot pressure supplied by the energized control valve 160. The high-pressure fluid is delivered to each main cylinder 16 thus causing pressurization of each main cylinder. Since the main cylinders 16 are substantially larger than the jack cylinders 17, significant clamping pressure is generated by the cylinders 16 and exerted on the movable bolster 12 thus generating a substantial clamping force on the platens 14.

During the clamping portion of the cycle, material in the platens is generally subjected to heat. The combination of heat and pressure causes curing or vulcanization of the material carried by the platens 14.

At the conclusion of the curing portion of the cycle, the press must be opened to remove the processed material. In order to open the press, the pressure in the main and jack cylinders 16, 17 must be released and the fluid in those cylinders must be allowed to return the tank 100. To prevent damage to the material carried on the platens, the press must be depressurized in a controlled manner before it is opened. Once depressurized, the press can then be opened in order to remove the processed material. The controlled depressurization is achieved as follows. At the conclusion of the clamping step of the processing cycle, the high-pressure control valves 150, 114 are de-energized and return to their left positions shown in FIG. 2. In these control valve positions, the high-pressure supply conduit 180 is isolated from the prefill valves 146 and the jack cylinder feed conduit 120. A depressurization control valve 190 which may be a proportional valve is energized in a controlled manner to communicate a return conduit 192 with the tank 100.

As seen in FIG. 2, the return conduit 192 communicates with each of the main cylinder feed conduits 147 through a check valve 191. The high-pressure fluid in the jack cylinders 17 can also be discharged through the depressurization valve 190 via a crossover conduit 198 that is connected to the return conduit 192 and which includes a check valve 191. The degree to which the depressurization valve 190 is energized determines the rate of flow through the valve. By controlling the degree to which the depressurization valve is opened, the rate at which pressure in the main cylinders 16 and the jack cylinders 17 is released, is controlled. By depressurizing the cylinders 16, 17 in a controlled manner damage to the material carried by the platens is avoided which would otherwise occur if the press was allowed to open quickly or suddenly.

When the pressure on the material carried by the platens is reduced to a suitable level, the solenoid 160 is de-energized in order to cause it to shift towards the left to the position shown in FIG. 2. In this position, pilot pressure is no longer applied to the prefill valves 146 and as a consequence they shift to the left thus communicating the main cylinder feed conduits with the branch conduits 145. Solenoid operated valve 162 is also energized to move the control valve downwardly as viewed in FIG. 2. This connects header 142 to tank 100 allowing fluid in the main cylinders to return to the tank. Finally control valve 126 is energized; this moves the control spool leftward, and thus vents the top of the DIN poppet valve 124 allowing it to open. the fluid in the jack cylinders can then return to the tank 100′ as the press opens.

In the illustrated embodiment, the press is opened by allowing the lower bolster 12 to lower under its own weight. As the movable bolster 12 moves downwardly under the influence of gravity, it forces the fluid in the main and jack cylinders 16, 17 back to the tank 100 via the return control valve 162 and the DIN valve 124, respectively.

The embodiment illustrated in FIG. 2, also includes an accumulator subsystem indicated by the dashed line 170. Referring also to FIG. 2c, the accumulator subsystem 170 enhances the rate at which the jack cylinders 17 are raised during the press closing step. In particular, the accumulator subsystem 170 includes an accumulator 172 that is pressurized by gas supplied by one or more tanks 174 containing gas under pressure. The accumulator 172 includes a portion 172a containing gas and a portion 172b containing liquid. The liquid portion 172b of the accumulator 172 is connected to the high-pressure supply conduit 110 via an accumulator feed conduit 181 that includes an electrically operated control valve 182.

In the illustrated embodiment, the accumulator 172 is charged by at least one of the positive displacement pumps 104′. In the disclosed embodiment, the one pump 104′ is used to charge the accumulator. It should be noted that depending on the application additional positive displacement pumps 104 may be utilized to charge the accumulator 172. As indicated above, the communication of the output of the pump 104′ with the supply conduit 110 is determined by the electrically operated control valve 112. In FIG. 2, the control valve 112 is shown shifted to the right at which position, the output of the pump 104′ is connected to the supply conduit 110. When the control valve is shifted to the left (as viewed in FIG. 2) the output of the pump 104′ is connected to an accumulator feed conduit 186. In the preferred operation of the system, the control valve is maintained in its right-most position (as shown in FIG. 2) during the portion of the cycle where the jack cylinders 17 are being fed high pressure in order to move the bolster 12 to its uppermost position. Once the press is closed, i.e., the bolster reaches its uppermost position, the control valve 112 is shifted to the left so that the pump 104′ can deliver high-pressure fluid to and fill the accumulator 172. The pump 104′ continues to charge the accumulator 172 until a predetermined pressure is reached or until the beginning of the next closing cycle.

When the press is to be closed, i.e., the control valve 114 is moved to the right in order to communicate high pressure fluid in the supply conduit 110 to the jack cylinders 17, the accumulator control valve 182 shifts rightwardly to allow high pressure fluid in the accumulator 172 to be delivered to the supply conduit 110. The combination of the high pressure fluid in the accumulator 172 with the high pressure fluid being delivered by the positive displacement pumps 104, 104′ increases the rate at which fluid is delivered to the jack cylinders 17 thus increasing the rate at which the jack cylinders 17 extend in order to raise the bolster 12. The addition of the accumulator subsystem 170 thus reduces the closing time for the press.

Referring in particular to FIG. 2c, the accumulator subsystem 170 also includes a fluid flow control station 180 that includes a manual valve 180a (shown only in FIG. 2c) for discharging fluid in the accumulator 172 to tank 100′. It also includes a pressure relief valve 180b which opens to dump pressure in the accumulator 172 to the tank 100′ should a predetermined pressure be exceeded. Finally, it also includes an electrically controlled valve 180c which connects the accumulator 172 to the tank 100 when the hydraulic system is powered down or the press is not in use.

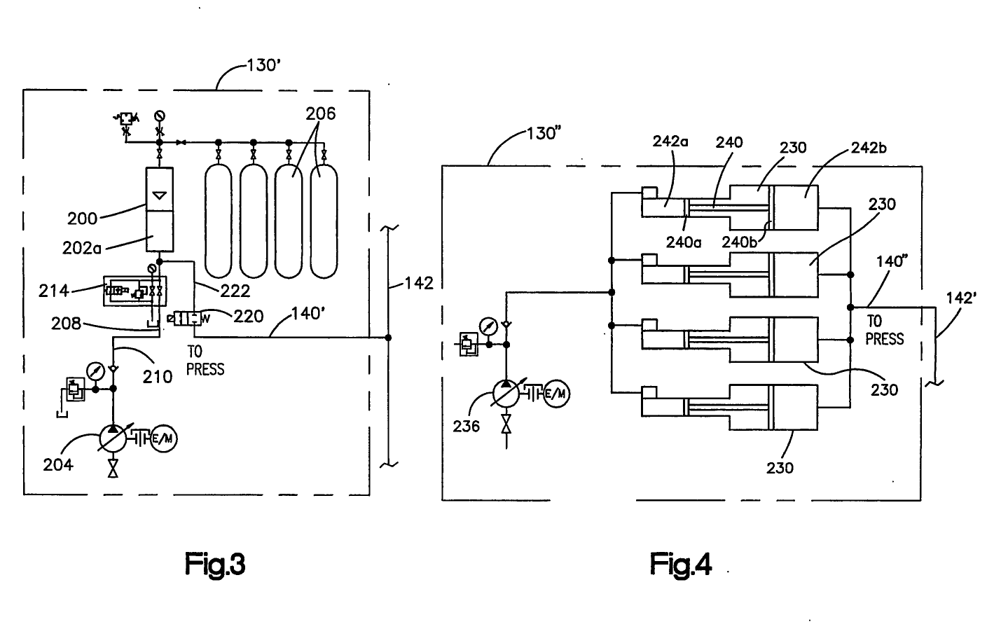

FIG. 3 illustrates an alternate method and apparatus 130′ for prefilling the main cylinders 16. In the alternative embodiment, an accumulator 200 is used to supply the prefill fluid (low pressure fluid at high volume) to the main cylinders 16. In this embodiment, a positive displacement pump 204 is used to charge a liquid side 200a of the accumulator 200. A plurality of tanks 206 containing gas under pressure is connected to the accumulator and supply the requisite pressure to drive the fluid out of the accumulator when desired. As seen in FIG. 3, the positive displacement pump 204 is connected to an accumulator feed conduit 208 via conduit 210. In the illustrated embodiment, the conduit 208 is connected to the accumulator 200 via a flow control station 214 which is the same or similar to the flow control station 180 described above. The conduit 142 as is described in connection with FIG. 2, is connected to the prefill valves 146 of the main cylinders 16. As seen in FIG. 2, the conduit 142 is also connected to the tank return, control valve 162. During the pressurization cycle, i.e., when the prefill valves 146 are energized to connect the high pressure conduit 152 with the main cylinders 16, the positive displacement pump 204 delivers fluid to the accumulator 200 thus charging the accumulator. During the press closing portion of the cycle, i.e., when the prefill valves 146 are de-energized (and in the positions shown in FIG. 2 to allow filling of the main cylinders 16), an accumulator control valve 220 is shifted rightwardly from its closed position shown in FIG. 3. This allows the accumulator 200 to discharge its stored fluid into the main cylinders 16 as the bolster 12 is raised by the jack cylinders 17, via a discharge conduit 222 (which is connected to the supply conduit 140′ by the control valve 220) and the de-energized prefill valves 146.

FIG. 4 illustrates another alternate apparatus and method 130″ for prefilling the main cylinders 16 during the press closing cycle. In the embodiment shown in FIG. 4, flow intensifiers 230 are used to deliver fluid to a prefill supply conduit 142′. The prefill supply conduit 142′ is similar to the prefill supply/return conduit 142 shown in FIG. 2 except that it does not include the tank return control valve 162 or a connection to the tank 100.

In this embodiment, the fluid from the main cylinders 16 that is discharged as the press opens are used to fill the flow intensifiers 230. During the press closing step, a positive displacement pump 236 is used to drive the flow intensifiers 230 rightwardly. As seen in FIG. 4, each intensifier 230 comprises a piston assembly 240 including small piston 240a connected to a much larger piston 240b that reciprocate in associated piston chambers 242a, 242b. The dispositive displacement pump 236 is connected to the chamber 242a in which the small piston 240a operates. The large piston 242b operates in the large volume chamber 242b. With the disclosed construction, the dispositive displacement pump 236 delivers fluid from the tank 100, under pressure to the chambers 242a of the flow intensifiers 230. A relatively small volume of fluid under high pressure causes a shifting of the large pistons 240b thus producing a large volume of fluid to be delivered to the supply conduit 140″. In the preferred embodiment, the total volume of the large chambers 242b is substantially equal to the volume of the main cylinders 16. In the preferred embodiment, when the positive displacement pump 236 causes the piston assembly 240 to shift to the right, fluid in an amount equal to the amount of fluid needed to fill the main cylinders 16 is delivered to the supply/return conduit 142′.

In this embodiment, fluid discharged by the main cylinders 16 during the opening cycle is simply returned to the large chambers 242b of the flow intensifiers 230 and causes the piston assemblies 240 to shift leftwardly. With this arrangement, the fluid from the main cylinders 16 is not returned to the tank. The exhausted fluid is simply returned to and stored in the flow intensifiers 230 and is ultimately redelivered to the main cylinders 16 during the next press closing step.

Although the invention has been described with a certain degree of particularity, it should be understood that those skilled in the art can make various changes to it without departing from the spirit or scope of the invention as hereinafter claimed.

1. A platen press, comprising:
a) a fixed bolster and a movable bolster between which is positioned at least one platen;
b) at least one fluid pressure operated jack cylinder for moving said movable bolster to a closed position;
c) a main, pressurizing cylinder for applying a clamping force to said platen when the movable bolster is in its closed position;
d) a first source of pressurized fluid, said pressurized fluid of said first source being at a first pressure;
e) a second source of pressurized fluid, said pressurized fluid of said second source being at a second pressure;
f) said second pressure being lower than said first pressure;
g) control valving for communicating said first source of pressurized fluid with said jack cylinder while concurrently communicating said second source of pressurized fluid with said main cylinder, during a press closing step of a press operating cycle;
h) said control valving being further operative, during a clamping step of the platen press operating cycle, to communicate said first source of pressurized fluid with said main cylinder while terminating the communication of said second source of pressurized fluid with said main cylinder.

2. The platen press of claim 1 wherein said platen press comprises a plurality of jack cylinders and a plurality of main cylinders.

3. The apparatus of claim 1 wherein said first source of pressurized fluid comprises at least one positive displacement pump.

4. The platen press of claim 1 wherein said first source of pressurized fluid comprises at least one positive displacement pump and an accumulator for accumulating pressurized fluid delivered by said pump during portions of the press operating cycle.

5. The platen press of claim 1 wherein said second source of pressurized fluid comprises at least one high volume, centrifugal pump.

6. The platen press of claim 1 wherein said second source of pressurized fluid comprises a fluid pump feeding an accumulator.

7. The platen press of claim 1 wherein said second source of pressurized fluid comprises a flow intensifier for delivering fluid to and receiving fluid from said main cylinder during press closing and press opening portions of the operating cycle of said platen press, respectively.

8. The platen press of the claim 7 wherein said flow intensifier includes a positive displacement pump for communicating fluid under pressure to an input side of a flow intensifier unit, the output of said flow intensifier being connectable to said main cylinder during portions of said press operating cycle.

9. A method of operating a platen press, the platen press including a fixed bolster, a movable bolster, at least one platen position between said bolsters and at least one jack cylinder and one main cylinder operatively connected to said movable bolster, comprising the steps of
a) communicating pressurized fluid at a first pressure from a first source to said jack cylinder while concurrently communicating pressurized fluid at a second pressure, from a second source to said main cylinder, during a press closing cycle;
b) upon press closure, communicating pressurized fluid from said first source to said main cylinder in order to generate a clamping force on said platen;
c) communicating said jack cylinder and said main cylinder to respective discharge conduits in order to permit opening of said platen press during a press opening step.

10. The method of the claim 9 wherein the communication of said first source of pressurized fluid comprises a step of energizing at least one positive displacement pump and communicating the output of said pump with said jack cylinder.

11. The method of the claim 9 wherein said step of communicating said first source of pressurized fluid comprises communicating a stored source of pressurized fluid with said jack cylinder.

12. The method of the claim 10 wherein said step of communicating said second source of pressurized fluid comprises the step of activating a high volume, centrifugal pump and connecting its output to said main cylinder.

13. The method of the claim 10 wherein said step of communicating said second source of pressurized fluid comprises a step of activating a positive displacement pump in order to operate a flow intensifier, the output of which is connected to said main cylinder.

14. The method of claim 10 wherein said step of communicating said second source of pressurized fluid comprises a step of communicating an accumulator containing stored pressurized fluid with said main cylinder.

15. The method of claim 10 wherein said movable bolster is moved to its open position by communicating said jack and main cylinders with a fluid reservoir and allowing the weight of said movable bolster to urge the movable bolster to its open position.

16. For a platen press of the type having fixed and movable bolsters, a plurality of jack cylinders for moving the movable bolster to a closed position and a plurality of clamping cylinders for exerting a clamping force on one or more platens held between the fixed and movable bolsters, the improvement comprising:
a) a first source of pressurized fluid including at least one positive displacement pump for supplying pressurized fluid at a first pressure;
b) a second source of pressurized fluid including a fluid supplying device capable of providing pressurized fluid at a relatively high volume and at a second pressure less than said first pressure;
c) a control system including control valving for communicating said first source of pressurized fluid to said jack cylinders while concurrently communicating said second source of pressurized fluid with said main cylinders in order to move said movable bolster to a closed position; and,
d) said control valving being further operative when said bolster is in its closed position, to communicate said first source of pressurized fluid to said main cylinders while terminating the communication of said second source of pressurized fluid with said main cylinders.

17. The improvement of claim 16 further comprising control valving for communicating said jack and main cylinders with a fluid reservoir in order to discharge fluid from the main and jack cylinders, whereby said movable bolster is moved to an open position.

18. The improvement of claim 17 wherein said control valving comprises a plurality of solenoid operated control valves.

19. The improvement of claim 16 wherein said first source of pressurized fluid comprises a plurality of positive displacement pumps.

20. The improvement of claim 19 wherein said first source of pressurized fluid further comprises an accumulator supplied with pressurized fluid by at least one of said positive displacement pumps.

21. The improvement of claim 16 wherein said second source of pressurized fluid comprises a plurality of high volume, centrifugal pumps.

22. The improvement of claim 16 wherein said second source of pressurized fluid comprises an accumulator fed by a fluid pump.

23. The improvement of claim 16 wherein said second source of pressurized fluid comprises a flow intensifier system which includes at least one flow intensifier unit operated by a fluid pump with the output of said flow intensifier unit being connectable to said main cylinders, whereby fluid can be delivered to, and received from, said main cylinders as said movable bolster moves to its closed position and as said movable bolster moves to its open position, respectively.
